(19) United States
(12) Patent Application Publication
(10) Pub. No.: US 2008/0292868 A1
(43) Pub. Date: Nov. 27, 2008

(54) FOAM CORE GYPSUM SHUTTER

(76) Inventor: J. Richard Logan, Oxford, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 12/124,835

(22) Filed: May 21, 2008

Related U.S. Application Data
(60) Provisional application No. 60/939,265, filed on May 21, 2007.

(51) Int. Cl. B32B 27/04

(52) U.S. Cl. 428/319.9; 264/279.1; 249/83

(57) ABSTRACT

A shutter assembly, or other architectural structure or exterior/interior decorative trim element, having a foam insert at least partially enveloped by a cementitious shell. The assembly is molded from cementitious slurry, including gypsum cement and a latex/water mixture. An amount of the slurry is added onto a bottom mold surface portion to a desired depth and/or weight. The foam insert is provided with a plurality of spacer elements disposed in a surface thereof, which is placed atop the slurry in a desired orientation, whereupon an additional amount of the slurry is then added so as to at least partially envelop the foam core or insert. Engagement members on the top mold portion are then brought into contact with the spacer elements so that the foam insert remains at least partially submerged within the slurry. A top portion of the spacer elements can be removed from a base portion of the spacer element to reveal a bore formed in the base portion. The bore can receive a fastening or mounting member to facilitate painting or mounting of the shutter assembly. After sufficient curing, the shutter assembly is removed from the mold and is ready for immediate use and/or further processing.

### CROSS-REFERENCED TO RELATED APPLICATION

The instant application claims priority to U.S. Provisional Patent Application Ser. No. 60/939,265, filed May 21, 2007, the entire specification of which is expressly incorporated herein by reference.

### FIELD OF THE INVENTION

The present invention relates to architectural and exterior/interior decorative trim elements, such as shutter assemblies, and more specifically to architectural and decorative trim elements, such as shutter assemblies, formed from cementitious slurries, especially those containing gypsum.

### BACKGROUND OF THE INVENTION

Many different modern building designs take advantage of various architectural and decorative trim elements, including modular shutters, for purely aesthetic purposes, e.g., to decorate exterior windows. Additional architectural and decorative trim elements can also be used in conjunction with other exterior elements of a building or structure, such as exterior doorways, arches, columns, pedestals, staircases, balustrades, railings, fountains, piers, wall caps, sills, and the like. Furthermore, interior trim elements, such as fireplace surrounds, mantle pieces, corbels, shelves, drapery brackets, sconces, finials, medallions, plaques, and the like can incorporate various architectural and decorative trim elements as well.

With respect to conventional modular shutter assemblies, they generally include an assembly of plastic parts that are individually formed and then secured together in a cost effective manner. The different plastic parts can be formed by different plastic fabrication techniques such as injection molding and extrusion. The plastic parts are secured together by appropriate fastening mechanisms, such as screws, adhesives, and/or the like, in a manner that is well understood in the art.

Because the shutters are employed for purely aesthetic purposes, it is important to choose an appropriate shutter style that complements, rather than detracts from, the exterior wall surface of the building onto which it is to be mounted. In this respect, certain buildings, especially upscale residential and commercial buildings having stucco, stone, and/or brick exterior walls, are generally not enhanced by the use of plastic or even metallic shutters, regardless of the quality and/or cost thereof. That is, the use of a plastic or metallic shutter does not, from an aesthetic viewpoint, coordinate very well with a building having stucco, stone, and/or brick exterior walls.

Additionally, it has been problematic to install shutter assemblies to the building's exterior walls without having to drill large and deep holes therein to accommodate screws that hold the shutter assemblies securely in place. These holes provide ingress for water, dirt, insects, and/or the like that could damage the wall or other surrounding structures. Toward this end, certain municipalities have enacted regulations on if, and how, holes can or cannot be provided in exterior walls for any purpose, including the hanging of shutter assemblies.

Therefore, it would be advantageous to provide architectural and exterior/interior decorative trim elements, including but not limited to shutter assemblies, which overcome at least one of the aforementioned problems.

### SUMMARY OF THE INVENTION

The present invention provides an architectural and/or exterior/interior decorative trim element, such as but not limited to a shutter assembly, having a foam core at least partially enveloped by a cement or cementitious exterior shell, especially cementitious materials containing gypsum (e.g., calcined gypsum). The cementitious shell can also be provided with one or more optional mounting members that allow the shutter assembly to be mounted to a fastener member that in turn could be mounted to a dwelling e.g., via a bracket affixed to an exterior wall surface thereof. The shutter assembly is formed in a substantially open mold from cementitious slurry comprising gypsum cement (e.g., calcined gypsum) and a latex/water mixture. The slurry can also contain other materials, such as but not limited to reinforcement materials (e.g., fibers), as well as other materials that are known in the art (e.g., activators, set preventers, plasticizers, fillers, and/or the like), which can be added before and/or after the combination of the gypsum and latex/water mixture.

With respect to the production process, an appropriate amount of the cementitious slurry is added onto a bottom mold surface portion to a desired depth. A foam core is then placed atop the cementitious slurry in a desired orientation. The foam core can have a plurality of mounting members placed into the rear surface thereof, the mounting members having a bore provided therein for receiving a fastening member for post-production processing (e.g., painting) and mounting (e.g., for accepting a mounting bracket thereto). An additional amount of the cementitious slurry is then added on top of the foam core so as to at least partially encapsulate the foam insert, especially the region where any mounting members have been inserted. A substantially open structure referred to as the top mold portion is brought into contact with the mounting members of the foam core so as to keep the foam core at least partially submerged within the cementitious slurry during the drying or curing process. By way of a non-limiting example, adjustable engagement members can be provided on arm members of the top mold portion that extend over the bottom mold surface portion, such that the engagement members substantially align with the mounting members placed in the foam core. In this manner, the engagement members maintain close contact with the mounting members, thus keeping the foam core at least partially submerged within the cementitious slurry. During one or more of the aforementioned stages, the mold can be vibrated and force/pressure applied to keep the top mold portion in close engagement with the bottom mold surface. After an appropriate curing or drying time, the product, e.g., a shutter assembly, is removed from the mold and is ready for immediate use and/or further processing, such as but not limited to painting and/or the like. The mounting members, which are at least partially enveloped by the cured cementitious slurry so as to remain firmly attached to the underlying foam core, can receive fastening members, such as screws and/or brackets, to facilitate any further processing and/or mounting.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front elevational view of a dwelling having a plurality of shutter assemblies mounted thereto, in accordance with a first embodiment of the present invention;

FIG. 2 is a front elevational view of a louvered shutter, in accordance with a second embodiment of the present invention;

FIG. 3 is a front elevational view of a panel shutter, in accordance with a third embodiment of the present invention;

FIG. 4 is a front elevational view of a batten shutter, in accordance with a fourth embodiment of the present invention;

FIG. 5 is a perspective view of a louvered shutter, in accordance with a fifth embodiment of the present invention;

FIG. 6 is a partial sectional view taken along line 6-6 of FIG. 5, in accordance with a sixth embodiment of the present invention;

FIG. 7 is a sectional view taken along line 7-7 of FIG. 5, in accordance with a seventh embodiment of the present invention;

FIG. 8 is an exploded view of a molding system for forming a shutter assembly, in accordance with an eighth embodiment of the present invention;

FIG. 9 is a perspective view of a bottom molding member on a conveyor system, in accordance with a ninth embodiment of the present invention;

FIG. 10 is an exploded view of a mold surface member and the bottom molding member on the conveyor system depicted in FIG. 9, in accordance with a tenth embodiment of the present invention;

FIG. 11 is a perspective view of a cementitious slurry being added onto the mold surface member depicted in FIG. 10, in accordance with an eleventh embodiment of the present invention;

FIG. 12 is an exploded view of a foam insert and the slurry/mold surface member/bottom molding member combination on the conveyor system depicted in FIG. 11, in accordance with a twelfth embodiment of the present invention;

FIG. 13 is a perspective view of the foam insert/mold surface member/bottom molding member combination on the conveyor system depicted in FIG. 11, in accordance with a thirteenth embodiment of the present invention;

FIG. 14 is a perspective view of a cementitious slurry being added onto the foam insert depicted in FIG. 13, in accordance with a fourteenth embodiment of the present invention;

FIG. 15 is a perspective view of the foam insert being substantially enveloped by the cementitious slurry, in accordance with a fifteenth embodiment of the present invention;

FIG. 16 is an exploded view of the upper mold member and the lower mold member depicted in FIG. 15, in accordance with a sixteenth embodiment of the present invention;

FIG. 17 is a perspective view of the upper mold member being brought into contact with the lower mold member depicted in FIG. 16, in accordance with a seventeenth embodiment of the present invention;

FIG. 18 is a perspective view of the fastening devices connecting the upper mold member to the lower mold member depicted in FIG. 16, in accordance with a eighteenth embodiment of the present invention;

FIG. 19 is an elevational view of a fireplace mantle having decorative corbel members prepared in accordance with the general teachings of the present invention affixed thereto, in accordance with a nineteenth embodiment of the present invention;

FIG. 20 is a perspective view of a corbel member depicted in FIG. 19, in accordance with a twentieth embodiment of the present invention; and

FIG. 21 is a perspective view of a mold surface member operable to produce the corbel member depicted in FIG. 20, in accordance with a twenty-first embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Referring to the Figures generally, a shutter assembly is generally disclosed at 10. By “assembly,” as that term is used herein, it is meant at least one shutter member. Although the present invention will be described with primary reference to shutter assemblies, it should be appreciated that the present invention can be practiced with any type of architectural and exterior/interior decorative trim element, especially those having a foam core or insert, regardless of whether the foam core or insert is partially or fully enveloped by a cementitious slurry and/or the like.

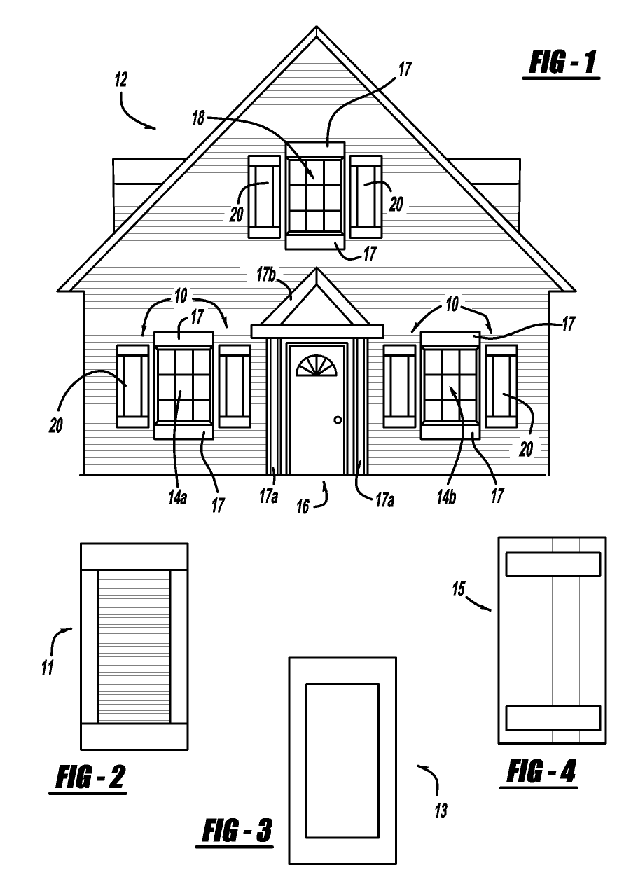

The shutter assembly 10 can be mounted, either permanently or temporarily to a dwelling 12, such as a residential or commercial building, especially one that includes a stucco, stone and/or brick exterior. FIG. 1 shows an exterior front view of a house 12 that includes two lower story front windows 14a, 14b, respectively, positioned on opposite sides of a door 16 and an upper story front window 18. Positioned on both sides of each of the windows 14a, 14b, 18, respectively, is a shutter assembly 10. The shutter assemblies 10 are rigidly secured to a front wall of the house 12 by appropriate securing devices, to be described herein, at a location that aesthetically accents the windows 14a, 14b, 18, respectively. Additionally, window panels 17 can either be placed above or below the windows for added aesthetic value. Also, pilasters 17a and pediments 17b can be placed around and above the door 16 to further add to aesthetic appeal of the exterior appearance of the dwelling 12.

Although raised/recessed panel shutter members are shown in connection with the shutter assemblies 10 in FIG. 1, it should be appreciated that various other configurations of the shutter assembly 10 can be employed with the practice of the present invention. With specific reference to FIGS. 2-4, the shutter assemblies 10 of the present invention can include, without limitation, a louvered shutter member 11, a panel shutter member 13, a batten shutter member 15, and/or the like. Furthermore, any number of complex shapes can be formed in accordance with the teachings of the present invention, including objects that have intricate curved patterns and those with highly complex three-dimensional shapes.

It is to be understood that one shutter assembly 10 according to the present invention is a single shutter 20. That is, one shutter assembly 10 is one left side shutter or one right side shutter such that two shutters (i.e., a pair of shutters) are preferred. For example, with specific reference to FIGS. 5-7, each shutter assembly 10 has a top 22, a bottom 24 and two sides 26a, 26b, respectively, extending between the top 22 and bottom 24.

The shutter assembly 10 includes a foam insert or core 100 that is completely or at least partially or substantially completely enveloped or surrounded by a cementitious shell or coating 102. Various portions of the cementitious shell 102 can be permitted to infiltrate through various crevices, apertures, or spaces, if present, formed in the foam core 100, e.g., so as to form reinforcement or rib members at various locations within the shutter assembly 10.

In accordance with one aspect of the present invention, the cementitious shell 102 is formed from a cementitious or cement slurry. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement. The cementitious slurry preferably includes gypsum cement and a sufficient amount of water added thereto to produce a slurry having the desired consistency, i.e., not too dry nor not too watery. In accordance with one aspect of the present invention, the water is present in combination with a latex material, such that the powdered gypsum material is combined with the latex/water mixture to form the cementitious slurry.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄.½H₂O, e.g., calcined gypsum. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and set preventers or retarders to control the setting times of the slurry. For example, appropriate amounts of set preventers or retarders can be added to the mixture to increase the shelf life of the resulting slurry so that it does not cure prematurely. When the slurry to be used in molding operations, a suitable amount of an accelerator can be added to the slurry, either before or after the pouring operation, so as to increase the drying and/or curing rate of the slurry. Suitable accelerators include aluminum sulfate, potassium sulfate, and Terra Alba ground gypsum. Additional additives can be used to produce colored shutter assemblies 10, such dry powder metallic oxides such as iron and chrome oxide and pre-dispersed pigments used for coloring latex paints.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are suitable for use in the fiber composition of the present invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

In accordance with one aspect of the present invention, the cementitious slurry includes a gypsum cement material, such as but not limited to calcined gypsum (e.g., calcium sulfate hemihydrate), also commonly referred to as plaster of Paris. One source of a suitable gypsum cement material is readily commercially available from United States Gypsum Company (Chicago, Ill.) and is sold under the brand name HYDROCAL® FGR 95. According to the manufacturer, HYDROCAL® FGR 95 includes more than 95 wt. % plaster of Paris and less than 5 wt. % crystalline silica.

The gypsum cement material should include an approximate 30% consistency rate. That is, for a 10 lb. amount of gypsum cement material, approximately 3 lbs. of water of would be needed to properly activate the gypsum cement material. If a latex/water mixture is being used to create the cementitious slurry, and the mixture contains approximately 50 wt. % latex solids, then approximately 6 lbs. of the latex/water mixture would be needed, as the latex/water mixture only contains approximately 50 wt. % water, the remainder being the latex solids themselves.

In accordance with another aspect of the present invention, the cementitious slurry includes a melamine resin, e.g., in the dry form, which acts as a moisture resistance agent. The melamine resin is present in an amount of about 10% of the weight of the gypsum cement material. For example, if 10 lbs. of gypsum cement material are used, then approximately 1 lb. of the melamine resin would be used. One source of a suitable melamine resin is readily commercially available from Ball Consulting Ltd. (Ambridge, Pa.).

In accordance with still another aspect of the present invention, the cementitious slurry includes a pH adjuster, such as but not limited to ammonium chloride, a crystalline salt, which acts to ensure proper cross-linking of the latex/water mixture with the dry ingredients, especially the melamine resin. The ammonium chloride is present in an amount of about 1% of the weight of the gypsum cement material. For example, if 10 lbs. of gypsum cement material are used, then approximately 0.1 lbs. of the ammonium chloride would be used. One source of a suitable ammonium chloride is readily commercially available from Ball Consulting Ltd. (Ambridge, Pa.).

In accordance with yet another aspect of the present invention, the cementitious slurry includes a filler such as but not limited to fly ash (e.g., cenosphere fly ash), which acts to reduce the overall weight and/or density of the slurry. The fly ash is present in an amount of about 30% of the weight of the gypsum cement material. For example, if 10 lbs. of gypsum cement material are used, then approximately 3 lbs. of the fly ash would be used. One source of a suitable fly ash is readily commercially available from Trelleborg Fillite Ltd. (Runcorn, England).

Several of the wet and/or dry components of the cementitious slurry of the present invention are readily commercially available in kit form from the United States Gypsum Company under the brand name REDI-ROCK®. Additional information regarding several suitable components of the cementitious slurry of the present invention can be found in U.S. Pat. No. 6,805,741, the entire specification of which is expressly incorporated herein by reference.

One or more of the dry ingredients are to be combined with the liquid portion of the cementitious slurry, i.e., the latex/water mixture. If the latex/water mixture includes 50 wt. % latex solids, with the rest being water, then the latex/water mixture is present in an amount of about 60% of the weight of the gypsum cement material. For example, if 10 lbs. of gypsum cement material are used, then approximately 6 lbs. of the latex/water mixture would be used. One source of a suitable latex/water mixture is readily commercially available from Ball Consulting Ltd. (Ambridge, Pa.) under the brand name FORTON® VF-812. According to the manufacturer, FORTON® VF-812 is a specially formulated, all acrylic co-polymer (50% solids) which cross links with a dry resin to make the system moisture resistant and UV stable.

The resulting cementitious slurry of the present invention should possess the following attributes: (1) it should stay wet or flowable for as long as possible, e.g., days, weeks, months, as circumstances warrant; (2) it should self level, i.e., the slurry should level by itself without intervention from the user when introduced into or onto a mold face surface; and (3) it should contain a limited water content (e.g., compared to conventional gypsum cement slurries), i.e., it should not be so wet so as to take a very long time (e.g., several hours or even days) to dry or cure.

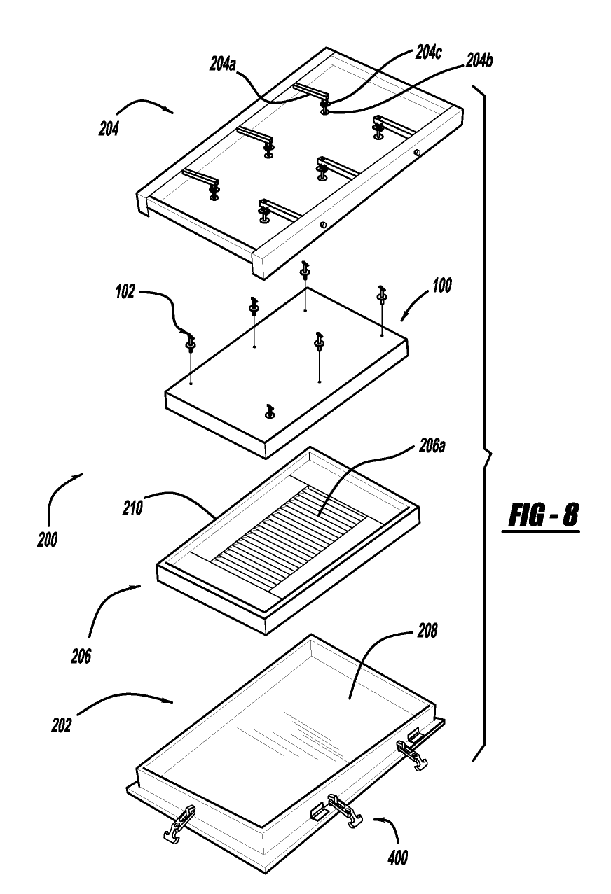

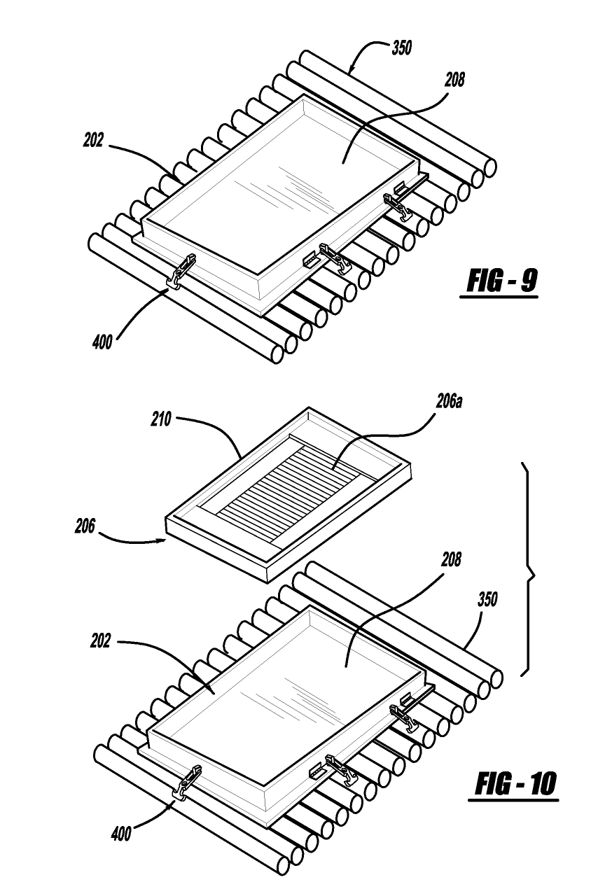

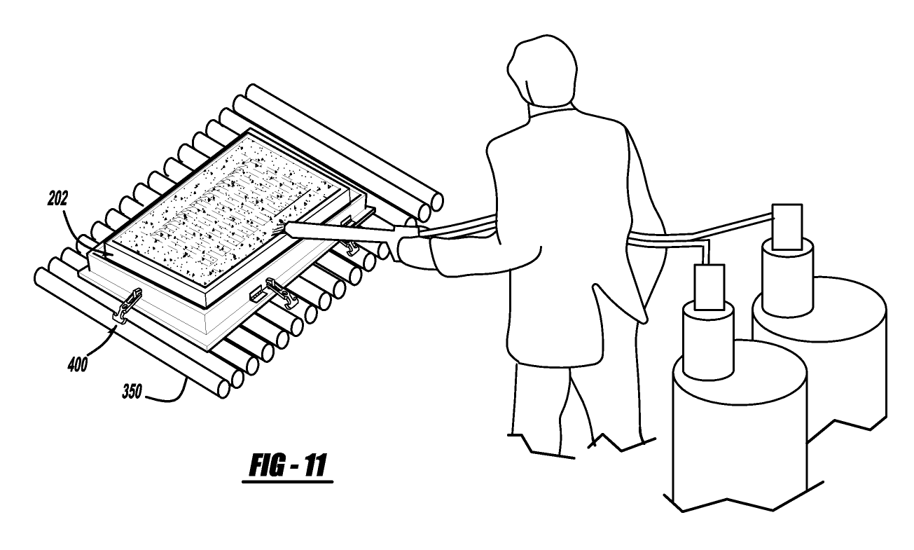

Referring to FIGS. 8-18, one illustrative system and method of forming the shutter assembly 10 of the present invention is shown as being formed in a substantially open mold system 200. With specific reference to FIG. 8, the mold system 200 includes a lower or bottom lower mold retainer support 202 and an upper or top mold portion 204 that are selectively operable to come into and out of contact with one another. It should be noted that the upper or top mold portion 204 does not include a mold face per se that imparts a surface feature to the final product, but rather is used to assist in the molding process itself, as will be described herein.

By way of a non-limiting example, the upper or top mold portion 204 can be hingedly attached to the lower or bottom lower mold retainer support 202, such that the upper or top mold portion 204 can rotate downwardly towards or upwardly away from the lower or bottom lower mold retainer support 202. Alternatively, the upper or top mold portion 204 can be freestanding such that it can be freely moved (either manually or mechanically) with respect to the lower or bottom lower mold retainer support 202. Additionally, the mold system 200, and components thereof, can be operated either manually and/or automatically.

A mold surface member 206 is preferably disposed within a cavity 208 formed in the lower or bottom lower mold retainer support 202. Although the lower or bottom lower mold retainer support 202 is shown as being an open shell having a substantially rectangular configuration, the lower or bottom lower mold retainer support 202 can have any number of various configurations. The mold surface member 206 can be formed of any type of material, such as rigid or flexible materials; however, preferably the mold surface member 206 is formed from a suitably flexible material that, e.g., can be removed from the cavity 208 (e.g., rubber, silicone, urethane and/or the like). The face 206a of the mold surface member 206 is essentially a negative image of the desired front and/or side exterior surface shape of the shutter assembly 10. Additionally, the mold surface member 206 preferably includes a peripheral lip member 210 to aid in grasping the mold surface member 206, e.g., when it is desired to remove the mold surface member 206 from the cavity 208. In this view, the foam core or insert 100 is shown for illustrative orientation purposes only.

Because of the weights involved of the various components, as well as the cementitious slurry, a transport device, such as a conveyor system 350 (e.g., see FIG. 9), either manually or automatically operated, can be employed to guide the mold system 200 along during the manufacturing process, e.g., from an initial processing station, to a curing station, and finally to a product removal station. In this manner, many shutter assemblies can be produced sequentially and rapidly (e.g., in an assembly line process) without having to wait for each individual shutter assembly to be finally and completely manufactured.

After the cementitious slurry has been prepared, as described above, the cementitious slurry, preferably when still wet, is then sprayed or poured into the mold surface member 206, either manually or mechanically, such that it contacts and fills the mold surface member 206 to a desired depth (e.g., see FIG. 11). By way of a non-limiting example, the cementitious slurry is poured onto the mold surface member 206 until it reaches a depth of about one-half way up the exterior wall of the mold surface member 206. Alternatively, the amount of the cementitious slurry could be added on the basis of weight, as opposed to volume. However, it should be appreciated that either less than or more than this amount (e.g., volume and/or weight) of the cementitious slurry can be used, e.g., depending on the specific application.

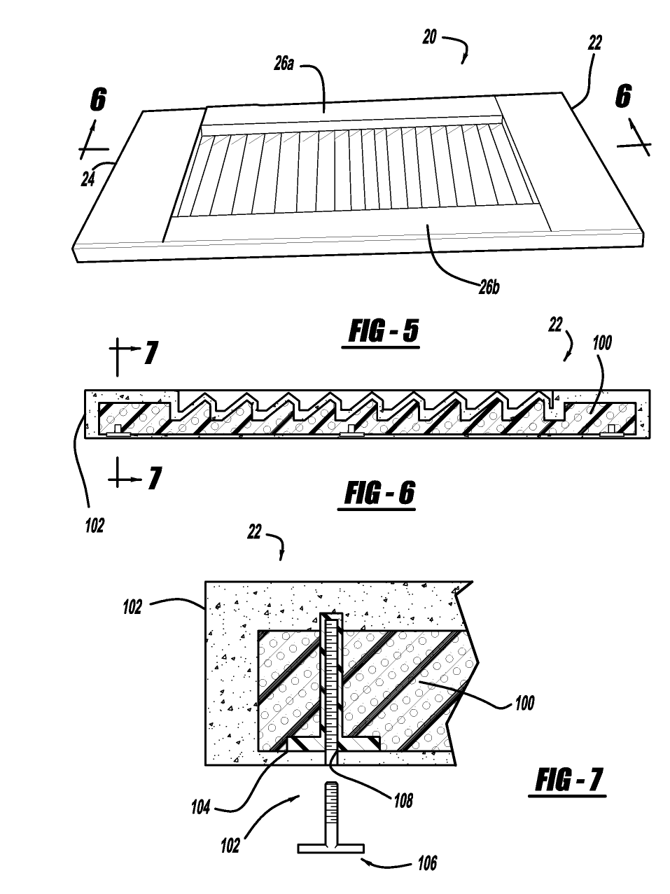

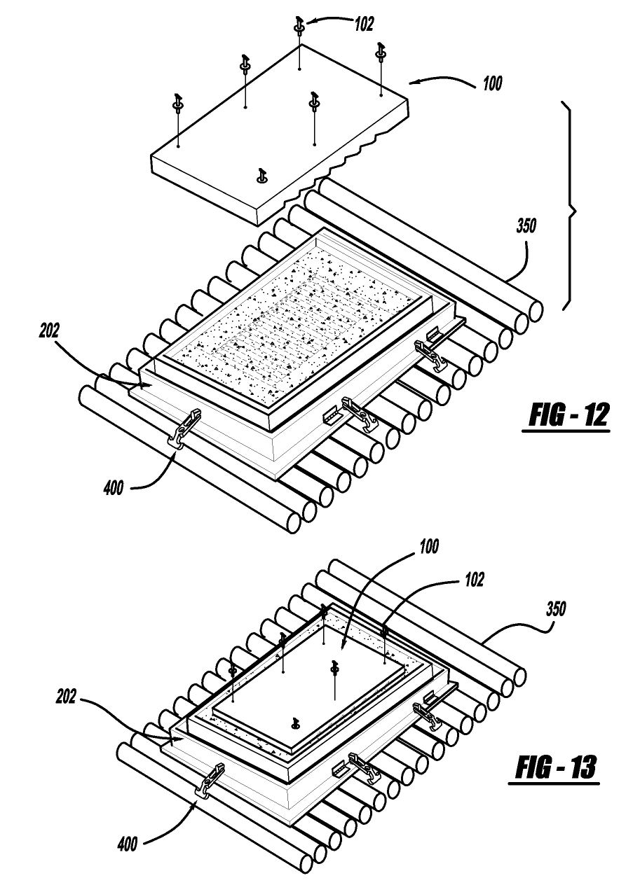

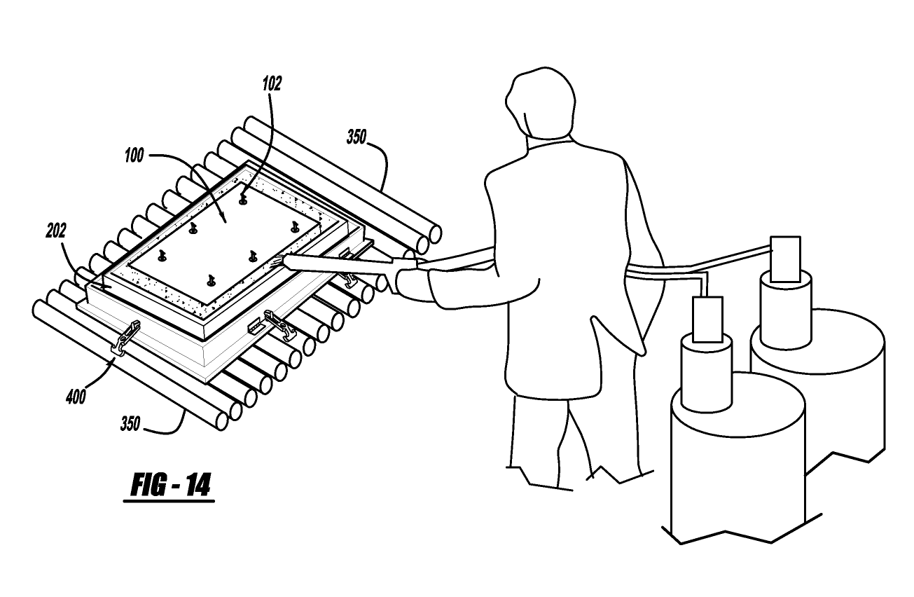

As noted, once a sufficient amount of the cementitious slurry is disposed onto the mold surface member 206, the foam core or insert 100 is then placed onto the cementitious slurry and is properly positioned in the mold in a desired orientation (see FIGS. 12 and 13). The foam core or insert 100 is preferably provided with one or more spacer elements 102 that are placed into the rear surface of the foam core or insert 100. One intended purpose of the spacer elements 102 is to provide a mechanism for ensuring that the foam core or insert 100 is at least partially or fully submerged within the cementitious slurry. Another intended purpose of the spacer elements 102 is to provide a mechanism for providing a mounting member in the rear surface of the finished product. The mounting member can include a bushing or bore (e.g., either smooth or threaded) that can accept a fastening member, such as a screw or bracket that can be received within the bushing or bore. In this manner, the finished product can be hung up for painting or can be mounted to a bracket for installation on a building or other structure. The spacer elements 102 can include any number of configurations, including a one-piece model that is raised up from the surface of the foam core or insert 100 which includes a bore formed therein, and a two-piece model that include a base portion 104 that lies flush with the surface of the foam core or insert 100 and a removable cap portion 106 that can be removed from the base portion, thus revealing a bore 108 formed in the base portion 104 (e.g., see FIG. 7). As previously noted, the bores can accept various fastening members.

At this point, an additional amount of the cementitious slurry is added, preferably on top of the foam core or insert 100 if a fully encapsulated final product is desired (e.g., see FIGS. 14 and 15), or alternatively, the additional amount of the cementitious slurry is placed around the periphery of the foam core or insert 100 if a partially encapsulated final product is desired. The cementitious slurry should be able to penetrate through any crevices, apertures or spaces between adjacent portions of the foam core or insert 100, such as the crevices, apertures or spaces formed between the individual slat members (not shown) and in this manner forms any reinforcement or rib members (not shown). Optionally, a vibratory force can be applied to the mold system 200, e.g., to remove any residual air bubbles in the cementitious slurry, e.g., either before or after the foam core or insert 100 is placed therein.

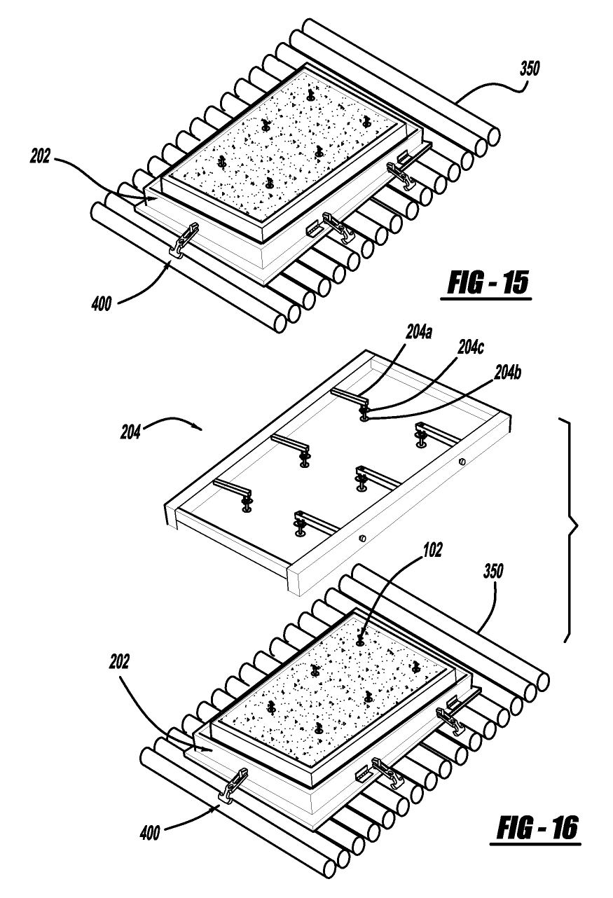

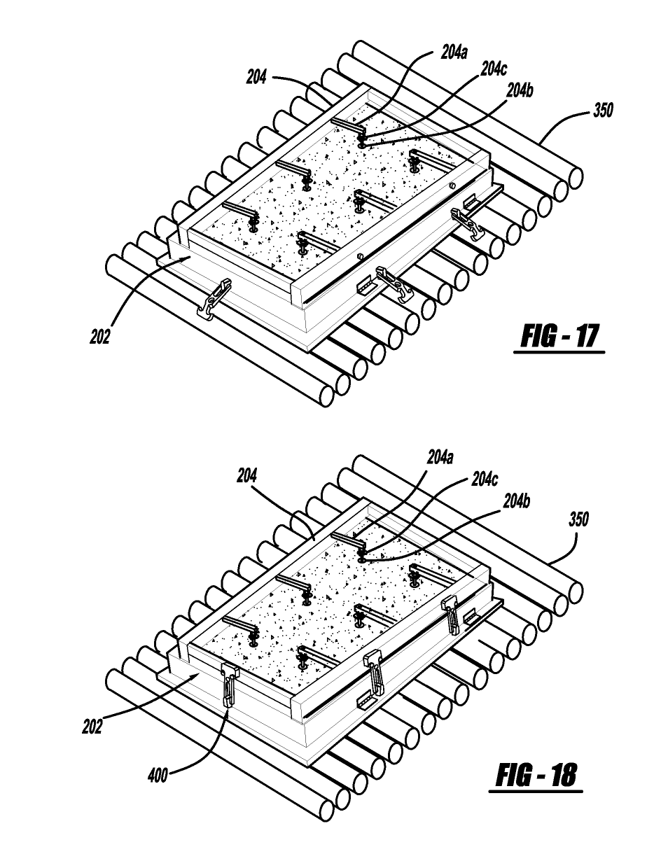

With specific reference to FIGS. 16 and 17, because the foam core or insert 100 can have a tendency to float, the upper or top mold portion 204 is brought into contact with the lower or bottom lower mold retainer support 202 so as to keep the foam core or insert 100 submerged within the cementitious slurry. Specifically, the arm members 204a of the upper or top mold portion 204 are provided with selectively adjustable engagement members 204b (e.g., similar to the adjustable leveling feet on a household appliance, such as a washing machine or stove). The engagement members 204b are positioned so as to substantially align with and contact the tops of the spacer elements 102 when the upper or top mold portion 204 is brought into engagement with the lower or bottom lower mold retainer support 202. In this manner, the engagement members 204b are axially adjustable downwardly and upwardly so as to contact the tops of the spacer elements 102 in a substantially parallel orientation. Once, the proper length of the engagement members 204b is determined, they can be locked in place with a locking member 204c (e.g., a nut and/or the like). In this manner, the foam core or insert 100 can be kept from excessively floating upwardly out of the cementitious slurry.

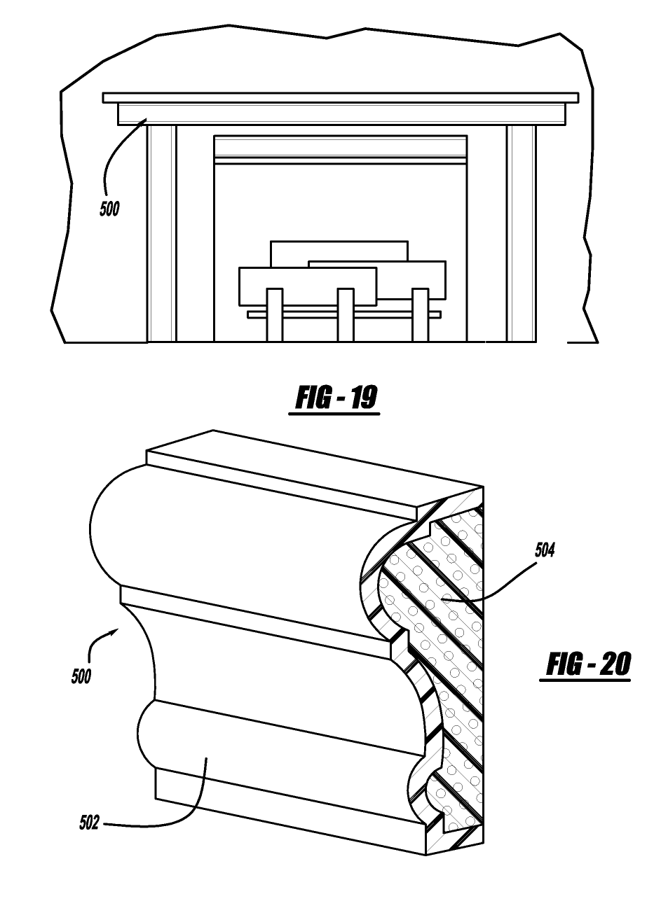

In accordance with one aspect of the present invention, the upper or top mold portion 204 can be secured to the lower or bottom lower mold retainer support 202 with fastening devices 400 so as to prevent the upper or top mold portion 204 and the lower or bottom lower mold retainer support 202 from becoming inadvertently dislodged from one another (see FIG. 18). The cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other shutter assemblies can be made in the interim.

Once the cementitious slurry has dried, hardened or cured, the shutter assembly 10 can then be removed from the mold system 200. By way of a non-limiting example, the fastening devices 400, if used, are disengaged so as to enable the upper or top mold portion 204 to be removed from the lower or bottom lower mold retainer support 202, thus exposing the rear face 10a of the shutter assembly 10. The mold surface member 206 can then be removed from the cavity 208 by grapping the peripheral lip member 210 and lifting the mold surface member 206 upwardly and out of the cavity 208. The mold surface member 206 is then removed from the shutter assembly 10, thus exposing the finished product, which is preferably allowed to dry to a suitable extent, after which time it can then be used immediately or further processed, e.g., painted or otherwise treated.

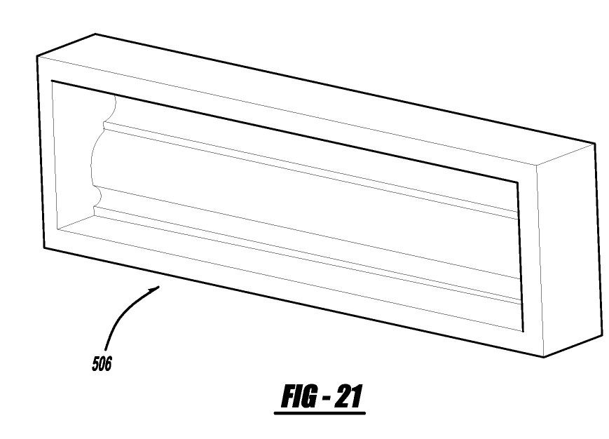

As previously noted, the present invention can be used to produce other architectural and exterior/interior decorative trim elements, especially those having a foam core or insert, regardless of whether the foam core or insert is partially or fully enveloped by a cementitious material and/or the like. With reference to FIGS. 19-21, trim elements 500 that are covered on one, two or three faces with a cementitious material 502, which at least partially envelops a foam core or insert 504, are encompassed by the present invention. In these cases, the rear surface is not covered by the cementitious material, and thus a surface of the foam core or insert 504 is exposed. In those applications where the rear surface of the finished product does not need to be enveloped with the cementitious material 502, the need to fully submerge the foam core or insert 504 is also eliminated or at least lessened. Thus, the need for spacer elements may also be eliminated or at least lessened with these particular products. Accordingly, mold face surfaces 506 can be employed to produce highly intricate shapes and patterns (e.g., see FIG. 21).

Thus, the present invention can produce many different types of architectural and decorative trim elements for use in conjunction with other exterior elements of a building or structure, such as but not limited to exterior doorways, arches, columns, pedestals, staircases, balustrades, railings, fountains, piers, wall caps, sills, and the like. Furthermore, the present invention can produce many interior trim elements, such as but not limited to fireplace surrounds, mantle pieces, corbels, shelves, drapery brackets, sconces, finials, medallions, plaques, and the like.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming a molded component, comprising:
providing a bottom mold surface member;
charging an amount of a latex and a urethane-based mixture onto the bottom mold surface member; and
disposing a foam member into the latex and urethane-based mixture such that the foam member is at least partially enveloped by the latex and urethane-based mixture.

2. The invention according to claim 1, further comprising providing an amount of a material selected from the group consisting of accelerators, set preventers, and combinations thereof for incorporation into the latex and urethane-based mixture.

3. The invention according to claim 1, further comprising providing an upper mold surface member operably associated with the bottom mold surface member.

4. The invention according to claim 3, wherein the upper mold surface member is selectively operable to cause the foam member to be at least partially submerged within the latex and urethane-based mixture.

5. The invention according to claim 3, wherein the upper mold surface member includes a surface portion having a plurality of protuberances formed thereon, wherein the protuberances are selectively operable to cause the foam member to be at least partially submerged within the latex and urethane-based mixture.

6. The invention according to claim 1, further comprising providing an insert selectively operable to be disposed within the bottom mold surface member, wherein the insert includes a surface configuration.

7. The invention according to claim 6, wherein the surface configuration is selectively operable to form a surface of an object selected from the group consisting of an architectural element, an exterior decorative element, and interior decorative element, and combinations thereof.

8. The invention according to claim 6, wherein the component is selectively operable to be removed from the insert after the urethane-based material has sufficiently cured.

9. The invention according to claim 1, wherein the component comprises an object selected from the group consisting of an architectural element, an exterior decorative element, and interior decorative element, and combinations thereof.

10. The invention according to claim 1, wherein the foam member is completely enveloped by the latex and urethane-based mixture.

11. The invention according to claim 1, further comprising providing a spacer member disposed on a surface of the foam member.

12. The invention according to claim 1, wherein the foam member includes at least one opening formed therein such that the latex and urethane-based mixture is selectively operable to penetrate therethrough.

13. The invention according to claim 1, wherein the latex and urethane-based mixture includes fly ash.

14. A molded component, comprising:
a foam member; and
a shell comprised of a latex and urethane-based mixture at least partially enveloping the foam member.

15. The invention according to claim 14, further comprising an amount of a material selected from the group consisting of accelerators, set preventers, and combinations thereof for incorporation into the latex and urethane-based mixture.

16. The invention according to claim 14, wherein the component comprises an object selected from the group consisting of an architectural element, an exterior decorative element, and interior decorative element, and combinations thereof.

17. The invention according to claim 14, wherein the foam member is completely enveloped by the latex and urethane-based mixture.

18. The invention according to claim 14, further comprising a spacer member disposed on a surface of the foam member.

19. The invention according to claim 14, wherein the foam member includes at least one opening formed therein such that the latex and urethane-based mixture is selectively operable to penetrate therethrough.

20. The invention according to claim 14, wherein the component is formed by:
charging an amount of the latex and urethane-based mixture onto a bottom mold surface member;
disposing the foam member into the latex and urethane-based mixture such that the foam member is at least partially enveloped by the latex and urethane-based mixture; and
allowing the latex and urethane-based mixture to cure for a sufficient period of time.

21. The invention according to claim 20, further comprising an upper mold surface member operably associated with the bottom mold surface member.

22. The invention according to claim 21, wherein the upper mold surface member is selectively operable to cause the foam member to be at least partially submerged within the latex and urethane-based mixture.

23. The invention according to claim 21, wherein the upper mold surface member includes a surface portion having a plurality of protuberances formed thereon, wherein the protuberances are selectively operable to cause the foam member to be at least partially submerged within the latex and urethane-based mixture.

24. The invention according to claim 20, further comprising an insert selectively operable to be disposed within the bottom mold surface member, wherein the insert includes a surface configuration.

25. The invention according to claim 24, wherein the surface configuration is selectively operable to form a surface of an object selected from the group consisting of an architectural element, an exterior decorative element, and interior decorative element, and combinations thereof.

26. The invention according to claim 24, wherein the component is selectively operable to be removed from the insert after the latex and urethane-based mixture has sufficiently cured.

27. The invention according to claim 14, wherein the latex and urethane-based mixture includes fly ash.

28. A system for forming a molded component, comprising:
a bottom mold surface member;
wherein an amount of a latex and urethane-based mixture is charged onto the bottom mold surface member;
wherein a foam member is disposed into the latex and urethane-based mixture such that the foam member is at least partially enveloped by the latex and urethane-based mixture.

29. The invention according to claim 28, further comprising an amount of a material selected from the group consisting of accelerators, set preventers, and combinations thereof for incorporation into the latex and urethane-based mixture.

30. The invention according to claim 28, further comprising an upper mold surface member operably associated with the bottom mold surface member.

31. The invention according to claim 30, wherein the upper mold surface member is selectively operable to cause the foam member to be at least partially submerged within the latex and urethane-based mixture.

32. The invention according to claim 30, wherein the upper mold surface member includes a surface portion having a plurality of protuberances formed thereon, wherein the protuberances are selectively operable to cause the foam member to be at least partially submerged within the latex and urethane-based mixture.

33. The invention according to claim 28, further comprising an insert selectively operable to be disposed within the bottom mold surface member, wherein the insert includes a surface configuration.

34. The invention according to claim 33, wherein the surface configuration is selectively operable to form a surface of an object selected from the group consisting of an architectural element, an exterior decorative element, and interior decorative element, and combinations thereof.

35. The invention according to claim 33, wherein the component is selectively operable to be removed from the insert after the latex and urethane-based mixture has sufficiently cured.

36. The invention according to claim 28, wherein the component comprises an object selected from the group consisting of an architectural element, an exterior decorative element, and interior decorative element, and combinations thereof.

37. The invention according to claim 28, wherein the foam member is completely enveloped by the latex and urethane-based mixture.

38. The invention according to claim 28, further comprising a spacer member disposed on a surface of the foam member.

39. The invention according to claim 28, wherein the foam member includes at least one opening formed therein such that the latex and urethane-based mixture is selectively operable to penetrate therethrough.

40. The invention according to claim 28, wherein the latex and urethane-based mixture includes fly ash.
